(19) United States
(12) Patent Application Publication
(10) Pub. No.: US 2004/0053074 A1
(43) Pub. Date: Mar. 18, 2004

(54) Magnetic recording medium and magnetic recording/reproducing system

(76) Inventors: Nobuhiro Jingu, Hita-shi (JP); Shigeharu Watase, Hita-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/396,722

(22) Filed: Mar. 26, 2003

(30) Foreign Application Priority Data
Mar. 27, 2002 (JP) 2002-087575

(51) Int. Cl. B32B 19/00

(52) U.S. Cl. 428/694 BB; 428/694 R

(57) ABSTRACT

The present invention provides a magnetic recording medium having a thinned film back coating layer as well as suppressed tribocharging by sliding to the tape guide pin on running, and having excellent running durability. The present invention also provides a magnetic recording/reproducing system using the magnetic recording medium above. A magnetic recording medium 1 which comprises at least a magnetic layer 3 and a protective layer 4 comprising a hard film containing carbon as a principal component in this order on one surface of a non-magnetic support 2, and comprises a metal layer 7 from 1 to 50 nm in thickness and a back coating layer 6 comprising a hard film containing carbon as a principal component in this order on the other surface of said non-magnetic support 2. A magnetic recording/reproducing system, for recording and reproducing a tape-like magnetic recording medium above, by using a magnetic recording/reproducing device having a member on which said hard film containing carbon as a principal component is formed at parts in contact with a surface of said back coating layer.

### BACKGROUND OF THE INVENTION

1. Field of the Invention

The present invention relates to a magnetic metal thin film type magnetic recording medium and to a magnetic recording/reproducing system.

2. Disclosure of the Related Art

With progress in information society, magnetic recording media capable of recording data at higher density are keenly demanded, and advances in magnetic recording layers,made a shift from the coated type to the so-called magnetic metal thin film type. Since being free from binders as the coated type magnetic recording media in the magnetic layer, the magnetic metal thin film type recording media yield high saturation magnetization and are suitable for high density recording. In the case of magnetic metal thin film type media, used Co—Ni alloys, Co—Cr alloys, Co—O alloys, and the like as the magnetic metals which are directly deposited by means of plating or vacuum thin film forming methods (such as vacuum deposition method, sputtering method, ion-plating method, and the like) on a non-magnetic support such as polyester film, polyamide film, polyimide film, and the like.

The most notable characteristic of long thin film media is that the recording capacity can be easily increased by elongating the winding length. However, due to the explosive increase in the amount of information in recent years, data storage tape with further increased capacity is demanded. In order to increasing the number of tape turns to cope with this requirement, method for enlarging the winding diameter, or for thinning the tape thickness are conceivable. The former results in necessity for re-designing not only the diameter of the reel, but also the cassette casing, and this leads to a considerable increase in production cost. On the other hand, the latter requires thinning the thickness of the film constructing the tape.

To take a tape formed by vacuum deposition which makes advance in thinning tape thickness as an example, a deposited film to be the recording layer has a thickness of about 200 nm, and the carbon-based protective film deposited thereon as a protective layer has a thickness of about 10 nm, a further thinning of these films has little contribution in decreasing the total tape thickness. In contrast to this, the support film has a thickness of about 5 μm, and the back coating layer on the side of running surface has a thickness of about 0.5 μm, and, an increase in the number of turns, i.e., an increase in capacity, can be expected by thinning these layers. However, a decrease in support film thickness leads to a lowered tape stiffness, and this unfavorably influences the recording/reproducing characteristics. Thus, it is believed most preferable to thin the back coating layers for reducing the tape thickness.

Back coating layers are generally formed by coating a support film surface with a coating material prepared from a material containing carbon black, inorganic pigments (such as calcium carbonate) and the like, and a solvent. However, by taking the coating technique into consideration in view of productivity, it becomes difficult to control the thickness of the back coating layer with high precision as the back coating layer thickness thins down.

In place of forming the back coating layer by coating, Japanese Patent Laid-Open No. 54935/1997 discloses a magnetic recording medium comprising double layered back coating layer comprising a 80 nm thick diamond-like carbon (DLC) thin film and on the support and a 90 nm thick graphite thin film on the diamond-like carbon thin film. Since a diamond-like carbon thin film has poor electric conductivity, and decreases tribocharging by sliding to the tape guide pin on running, a graphite thin film is provided thereon as a solid lubricant. However, in the case graphite thin film is provided on the sliding surface, friction in molecular level occurs to cause unfavorable dropouts due to the generation of particulates.

In Japanese Patent No. 2,638,113 disclosed is a magnetic recording media having a back coating layer comprising diamond-like carbon thin film formed on a fine-particle coated layer on a support. In order to reduce tribocharging due to sliding by the diamond-like carbon thin film, a fine-particle coated layer is provided as an undercoat layer. However, it requires providing a back coating layer comprising diamond-like carbon thin film on the undercoat layer with a thickness of about 0.4 μm on the support, and this cannot contribute to thin the tapes.

Furthermore, on forming a diamond-like carbon thin film directly on the non-magnetic support, since the non-magnetic support is fundamentally an electric insulating material, there is another problem that the film growth rate is extremely decreased in the case methods where charged particles such as plasma CVD and ion plating are nucleus of film growth.

As described above, the technique is yet to be realized for replacing the coating type back-coating layer, which is difficult to control the thin film thickness with high precision, with a back coating layer comprising diamond-like carbon thin film, although it is believed effective in thinning the total thickness of the tapes.

Furthermore, by thinning the back coating layer as diamond-like carbon thin film, the support film thickness can be increased at the expense of thinning the back coating layer in the case the total tape thickness is made the same as above. The lowest of the strength per unit thickness in data storage tapes at present is the back coating layer of a coated type, and by increasing the thickness of the support film brought by thinning the back coating layer, the strength of the tape as a whole can be increased to improve durability.

On the other hand, in Japanese Patent Laid-Open Nos. 44841/1997, 102051/1996, and 2000-339661 disclosed are an attempt of replacing the back coating layer with a metal thin film in order to compensate for tape stiffness by reducing the thickness of the tape. However, in the case vacuum deposition method, which is believed to yield relatively high production efficiency, is employed for the production of metal thin film, the non-magnetic supports are limited to those resistant to a large thermal load such as radiation heat from evaporation sources or solidification heat of deposited particles, such as polyaramid supports. In the case supports with relatively low heat resistance, such as PET or PEN, are used, the supports must be made sufficiently thick, and this results in retrogressing against thinning of the film.

### SUMMARY OF THE INVENTION

In light of such circumstances, there is demanded a technology of thinning the back coating layer by using diamond-like carbon thin film, further suppressing the generation of tribocharging attributed to diamond-like carbon thin film.

Accordingly, an object of the present invention is to provide a magnetic recording medium having a thinned film back coating layer as well as suppressed tribocharging by sliding to the tape guide pin on running, and having excellent running durability. Another object of the present invention is to provide a magnetic recording/reproducing system using the magnetic recording medium above.

The present inventors have extensively and intensively conducted studies, and as a result, they have found that the above objects can be achieved by providing, via a metallic layer on a support, a back coating layer comprising a hard film containing carbon as a principal component. The present invention has been accomplished based on these findings.

The present invention provides a magnetic recording medium which comprises at least a magnetic layer and a protective layer comprising a hard film containing carbon as a principal component in this order on one surface of a non-magnetic support, and comprises a metal layer from 1 to 50 nm in thickness and a back coating layer comprising a hard film containing carbon as a principal component in this order on the other surface of the non-magnetic support.

The present invention provides-above magnetic recording medium, wherein the magnetic layer is a metal thin film type magnetic layer.

The present invention provides above magnetic recording medium, wherein the back coating layer comprising the hard film containing carbon as the principal component is formed by a vacuum film forming method.

The present invention provides above magnetic recording medium, wherein the back coating layer has a thickness of from 3 to 300 nm.

The present invention provides above magnetic recording medium, wherein the metal layer is formed by employing, as a raw material, at least one selected from the group consisting of Al, Ag, Cr, Cu, Mn, Ti, Co, Ni, Zn, and alloys of the metals.

The present invention provides above magnetic recording medium, wherein the electric resistivity of the metal layer is in the range of from 10⁻² to 10¹⁰ Ω·cm.

The present invention provides above magnetic recording medium, which further comprises a lubricant layer on the protective layer.

The present invention provides above magnetic recording medium, which further comprises a lubricant layer on the back coating layer.

The present invention provides a magnetic recording/reproducing system, for recording and reproducing a tape-like magnetic recording medium above, by using a magnetic recording/reproducing device having a member on which the hard film containing carbon as a principal component is formed at parts in contact with a surface of the back coating layer.

In the present invention, “containing carbon as a principal component” signifies that content of atomic carbon in the film is from 60 to 80%, and in general, hydrogen is contained in the film in addition to carbon. The atomic ratio of hydrogen to carbon (H/C) is preferably in a range of from 0.25 to 0.66. “To be hard film” means, specifically, that to be a film having a Vicker's hardness of 6370 N/mm² (650 kg/mm²) or higher, and this hardness, as expressed by refractive index, corresponds to a value of 1.9 or higher. A film having such a refractive index is known that the hardness can be approximated from the refractive index. For instance, when a refractive index is 1.9the Vicker's hardness is 6370 N/mm² (650 kg/mm²). There is especially no upper limit in refractive index, but is about 2.25, and it corresponds to Vicker's hardness of 29400 N/mm² (3000 kg/mm²). As a method for obtaining approximate value of hardness from refractive index, there may be mentioned measuring the refractive index of the hard film with an ellipsometer, while measuring vicker'shardness with micro hardness meter (manufactured by NEC Corporation), and preparing a calibration curve in advance to find the value of hardness from the refractive index. Furthermore, such hard films are amorphous, or form a continuous phase that is nearly amorphous, and yield broad peaks at 1,560 cm⁻¹ and 1,330 cm⁻¹ when measured by Raman spectroscopy. The term hard carbon film or DLC film is employed hereinafter in the sense of “hard films containing carbon as a principal component”.

According to the present invention, there is provided a magnetic recording medium having a thinned film back coating layer as well as suppressed tribocharging by sliding to the tape guide pin on running, and having excellent running durability. Also according to the present invention, there is provided a magnetic recording/reproducing system using the magnetic recording medium above.

### BRIEF DESCRIPTION OF THE DRAWINGS

FIG. 1 is a cross section view showing an example of layer constitution of a magnetic recording medium according to the invention.

FIG. 2 is a cross section view showing an example of layer constitution of a magnetic recording medium according to the invention.

FIG. 3 is a schematic drawing of an apparatus for measuring slide friction coefficient.

FIG. 4 is an explanatory drawing showing the method for measuring cupping.

### DETAILED DESCRIPTION OF THE INVENTION

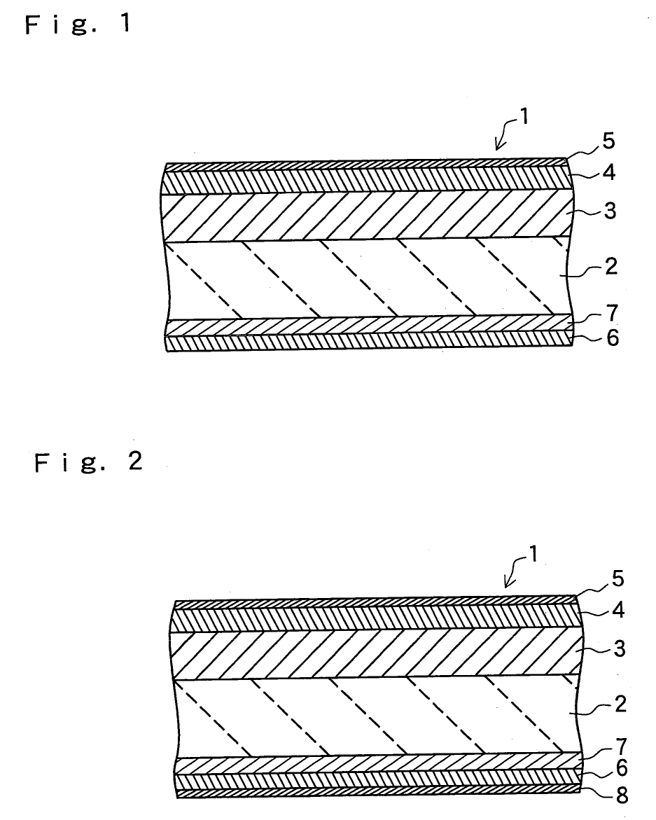

The magnetic recording medium according to the invention is described below by making reference to FIGS. 1 and 2.

FIGS. 1 and 2 are each cross section views showing an example of layer constitution of a magnetic recording medium according to the invention. Referring to FIG. 1, a magnetic recording medium (1) comprises, on the surface of one side of a non-magnetic support (2), a magnetic layer (3), a protective layer (4) comprising a hard carbon film, and a lubricant layer (5) in this order; and comprises, on the surface of the other side of the non-magnetic support (2), a back coating layer (6) comprising a hard carbon film, with a metal layer (7) intervening between them. In the example of FIG. 2, the magnetic recording medium (1) further has a lubricant layer (8) on the back coating layer (6).

There is no particular limitation concerning the material for the non-magnetic support (2), and is selected from resins such as polyester-based resins such as polyethylene terephthalate (PET) and polyethylene naphthalate (PEN), polyamide-based resins such as aromatic polyamides, and olefin-based resins such as polyethylene and polypropylene. The thickness of the non-magnetic support is selected from a range from 3 to 12 μm, depending on aimed time for imaging-recording or recording, or the like. In order to make the entire tape thinner, in particular, the thickness of the non-magnetic support is preferably selected from a range of 3 to 6 μm.

The magnetic layer (3) is formed on the surface of one side of the non-magnetic support (2) by means of vapor film forming methods such as vacuum deposition and ion plating. As the magnetic materials, used are Co or an alloy containing Co, such as Co—Ni, Co—Cr, Co—O, Fe—Co—Ni, Co—Pt, Co—Fe, and the like. In the case of vapor film forming such as vacuum deposition, those having similar boiling points are in the form of alloy, and those having different boiling points are subjected to multi-element vacuum deposition. In the case of sputtering and the like, on the other hand, metal or alloys are subjected to film forming as they are. A tape-like medium is subjected to oblique vapor film forming.

For the vacuum deposition of the magnetic layer, the magnetic material is molten by an electron gun after evacuating the inside of the vacuum deposition chamber to about 10⁻⁵ Torr, and the non-magnetic support is run along a cooled main roller (cooling can) at the point the entire magnetic material is molten, such that the vapor deposition may be initiated at the main roller part. In order to control the magnetic characteristics, an oxidizing gas selected from oxygen, ozone, and nitrous oxide may be introduced to the magnetic layer. In a long extended medium, oblique film forming is performed, such that the column is set to make an angle of 20 to 50 degrees with respect to the non-magnetic support. In the case of a vertical medium, on the other hand, the crucible is set just below the can to set the aperture portion of the mask at an angle within ±10 degrees.

The magnetic layer is a mono-layered or a multi-layered constitution. The thickness of the magnetic layer is in a range of about 0.01 to 0.5 μm.

A hard carbon film (DLC film) as a protective layer (4) is formed on the magnetic layer (3) by means of CVD or sputtering method. Both sputtering and CVD methods are processes using charged particles. Sputtering method is a physical process; firstly an inert gas such as gaseous Ar and the like is ionized (plasma generation) by using an electric field or a magnetic field, further the thus ionized argon ion is accelerated to knock out the target atoms by the kinetic energy, and the knocked out atoms are deposited on the substrate disposed opposed to the target to form the desired film. The film forming rate of DLC film using sputtering method is generally low, and it is a means of film forming inferior in productivity from industrial viewpoint. On the other hand, CVD method causes chemical reactions such as decomposition, synthesis, and the like of gas to be raw material using the energy of the plasma generated by ionization or magnetic field to thereby form a film. In the invention, there is no problem in using sputtering method, but preferred is CVD method capable of forming films at high speed.

As the gas for use in CVD method, those which are in the gaseous state under ordinary temperature and pressure, such as methane, ethane, propane, butane, ethylene, propylene, and acetylene, are easy for handling, or there is also, no problem in using liquid starting materials.

The gas above is introduced in a reaction system, high frequency is applied to generate plasma state, and vapor phase film forming is carried out. More specifically, in a chamber (vacuum cell) provided with supply roller, take-up roller, main roller equipped with partial cylindrical face electrode plates (with circular arc-shaped cross section) for plasma polymerization opposed to each other at a distance, and path roller if necessary, the starting material roll (wound non-magnetic support with a vapor deposited ferromagnetic metal into roll) is set on the supply roller, and then evacuate the chamber to a pressure as low as 10⁻⁵ Torr or lower, followed by performing plasma polymerization with introducing gaseous hydrocarbon at a predetermined amount such that the reaction pressure in a range of 1 to 10⁻² Torr would be achieved. The amount of the gas introduced is set optionally as required, because it depends on the size of the chamber.

There is no particular restriction concerning high frequency, however, stable discharge easy for handling is obtained in the range of from around 1 kHz to 1 MHz. At frequencies lower than 1 kHz, it is difficult to form film for a long time, and at frequencies higher than 1 MHz, it is not easy to obtain hard films. The range easy to operate is preferably in the range from about 50 kHz to 450 kHz. The film thickness of the hard carbon film is in a range of from 2 to 20 nm, and preferably in a range of around from 5 to 10 nm. A film thinner than 2 nm cannot exhibit its function as a protective film, on the other hand, films thicker than 20 nm suffer problems of spacing loss.

Since the lubricants are coated on the DLC film with difficulty, post-treatment may be performed after forming the DLC film. The post-treatment is preferably carried out by using gaseous oxygen or a gas containing oxygen, and usable gases are, for instance, oxygen, air, and gaseous carbon dioxide. The post treatment is easily performed by a procedure similar to that for forming DLC film. The frequency range for use in post-treatment is preferably in the range of from 1 kHz to 40 MHz like in forming DLC films, and particularly, effects are easily displayed in the range of from 50 kHz to 13.56 MHz.

A lubricant layer (5) is formed on the hard carbon protective layer (4) by coating. As the lubricant, a lubricant containing fluorine, a hydrocarbon based ester, or a mixture of these may be used.

The lubricant is, for instance, those having a basic structure expressed by R¹-A-R², where,

R¹: CF₃(CF₂)n—, CF₃(CF₂)ₙ(CH₂)ₘ—, CH₃(CH₂)₁—, or H;

A: —COO—, —O—, or —COOCH(C₁H₂₁₊₁)CH₂COO—; and

R²: CF₃(CF₂)ₙ—, CF₃(CF₂)ₙ(CH₂)ₘ—, CH₃(CH₂)₁—, or H; provided that preferably R¹ differs from R², and n satisfies a numeral in a range of from 7 to 17, m from 1 to 3,and 1 from 7 to 30. Furthermore, higher lubricating effect is displayed in the case R¹ and/or R2 are straight-chain group. In the case n is smaller than 7, water-repelling properties become low, and in the case n is larger than 17, friction cannot be lowered because blocking phenomenon occurs between the lubricant and the non-magnetic support or the back coating layer. Particularly preferred among them is a lubricant containing fluorine. Furthermore, two or more of these lubricants may be mixed.

A coating solution is prepared by dissolving these lubricants in a solvent such as ketones, hydrocarbons, and alcohols. As the ketones, there may be mentioned acetone, methyl ethyl ketone (MEK), methyl isobutyl ketone, cyclohexanone, diethyl ketone, and the like. As hydrocarbons, examples include normal- and iso-hydrocarbons such as hexane, heptane, octane, nonane, decane, undecane, and dodecane. Alcohols include methanol, ethanol, propanol, and isopropanol. Thus prepared coating solution is applied on the hard carbon protective layer (4) and dried to provide the lubricant layer (5). The thickness of the lubricant layer (5) is not to be measured accurately, but it is believed to be about several nanometers. The amount of lubricant may be controlled by the concentration of the coating solution. Forming of the lubricant layer (5) by coating may be performed after forming the back coating layer (6) comprising hard carbon film, which is later stated.

A metal layer (7) is formed on the surface of the other surface of the non-magnetic support (2). The metal layer (7) is preferably a metal thin film formed from a non-magnetic metallic material having no influence on the recorded information provided on the magnetic surface. In the case magnetic material such as Co and the like is used, it is necessary nearly to demagnetize it by turning into an oxide and the like. The metal layer (7) may be formed by a generally known vacuum thin film forming methods such as vacuum deposition method, sputtering method, ion-plating method, and the like. Since the metal thin films formed by such vacuum film forming methods are generally high in chemical activity, the method for lowering the activity by introducing an oxidizing gas such as oxygen into the films formed. Usable as metal materials are, for instance, Al, Ag, Cr, Cu, Mn, Ti, Co, Ni, Zn, and alloys of said metals and the like; in view of production efficiency of film forming, preferred are metal materials of low melting points, and ideal ones are, for example, Al and Al based alloys.

The metal layer (7) has a thickness of 1 to 50 nm, preferably, 1 to 40 nm, and more preferably, 10 to 40 nm. In the case the film thickness of the metal layer (7) exceeds 50 nm, unbalance occurs on the stress between the magnetic surface side and the tape running surface side, which results in an increase in tape cupping and a problem of decreasing in running stability. On the other hand, in the case the film thickness of this layer is less than 1 nm, the function of electric conductivity is impaired. From the viewpoint of film forming, a film with a thickness as thin as 1 to 50 nm reduces the problem of thermal load on the non-magnetic support on performing film forming, and supports comprising a material having relatively low heat resistance such as a PET and PEN may be sufficiently used.

The electric resistivity of the metal layer (7) is in a range of from 10⁻² to 10¹⁰ Ω·cm, preferably, it is in a range of 10⁻² to 10⁷ Ω·cm, and must be lower than that of the back coating layer (6) by at least one order of magnitude. Since-the metal layer (7) has such an electric conductivity, a desired electric conductivity can be maintained for the back coating layer (6) comprising hard carbon film formed on metal layer (7). Furthermore, the rate of film forming of the hard carbon films can be improved at the same time.

A hard carbon film (DLC film) as the back coating layer (6) is formed on the metal layer (7) in the same manner as in the case of the hard carbon protective layer (4).

The back coating layer (6) has at a thickness of about 3 to 300 nm, preferably, about 5 to 50 nm, and more preferably, about 5 to 10 nm. The DLC film is a carbon film higher in hardness, and it sufficiently functions as back coating with such a thickness. In the case the film thickness is less than 3 nm, the strength of the DLC film becomes insufficient to cause instability on the resistance against scratches.

An ordinary DLC film suffers low electric conductivity.

However, in the present invention, the back coating layer (6) comprising DLC film is formed on the metal film (7). Hence, the electric conductivity of the DLC film is higher as compared with that of a generally known DLC film. Accordingly, although in the magnetic recording medium of the present invention the back coating layer (6) comprises DLC film, the tribocharging that generates on the running tape due to sliding on the guide pin is considerably suppressed to exhibit excellent running durability. In this manner, a magnetic recording medium having a thinned film back coating layer (6) is obtained.

In the invention, a lubricant layer (8) may be further formed on the back coating layer (6). The lubricant layer (8) may be formed in a manner similar to the case of lubricant layer (5) formed on the protective layer (4) by using a similar material. The thickness of the lubricant layer (8) is not to be measured accurately, but it is believed to be about several nanometers.

On recording and reproducing the tape-like magnetic recording medium according to the present invention, an ordinary magnetic recording/reproducing device may be used. In an ordinary magnetic recording/reproducing device, various types of tape-sliding members such as tape guides and tape controlling guides are generally having stainless steel. In the magnetic recording medium of the present invention, tribocharging due to sliding against the members on running is considerably suppressed, hence, favorable recording/reproducing as well as excellent running durability can be obtained by using an ordinary magnetic recording/reproducing device.

However, since the back coating layer is DLC film in the magnetic recording medium of the present invention, in the case a magnetic recording/reproducing device comprising various members on which a hard carbon film is formed (which is sometimes referred to hereinafter as “DLC film coated treatment”) on the portion (or the surface) in contact with the surface of the back coating layer, i.e., the tape running surface is used, the friction coefficient on sliding the tape running surface on the various members is further lowered, and the tribocharging is further suppressed. The film thickness of the DLC film on the surface of the metallic various members may be about 1 μm; i.e., a thickness generally applied to tools and the like. By coating DLC films at such a thickness, friction properties can be sufficiently improved. Accordingly, the present invention also relates to a magnetic recording/reproducing system for recording and reproducing tape-like magnetic recording medium of the present invention, which uses a magnetic recording/reproducing device equipped with members on which hard carbon films is formed at parts that are brought into contact with the surface of the back coating layer.

### EXAMPLES

The invention is described further concretely by way of examples below, but it should be understood that the invention is not limited thereto.

### Example 1

A magnetic recording medium of the layer constitution shown in FIG. 1 was prepared by the following process.

A PEN film (2) 4.7 μm in thickness was used as a non-magnetic support. On one surface of the PEN film (2), a ferromagnetic thin film of Co was formed by oblique vacuum deposition to obtain a 0.1 μm thick magnetic layer (3). Then, on the magnetic layer (3), a protective layer (DLC film) (4) having a 10 nm thick hard carbon film was formed by means of plasma CVD method. Post-treatment (plasma treatment) was performed to the DLC film by using gaseous O₂.

Subsequently, by vacuum deposition, about 10 nm thick metal layer (7) was formed using Al on the surface of PEN film (2) opposite to the surface where the magnetic layer (3) is formed. In this case, vacuum deposition was carried out while supplying oxygen gas in order to lower the chemical activity of the film. Then, a back coating layer (DLC film) (6) having 10 nm thick hard carbon film was formed on the metal layer (7) by means of plasma CVD method.

Furthermore, on the protective layer (4), a lubricant coating solution is coated by dye nozzle method, and was dried to form a 5 nm thick lubricant layer (5). The resulting product was then cut to 8-mm width to obtain a magnetic tape sample having a total thickness of about 4.8 μm.

The lubricant coating solution was a solution obtained by dissolving a fluorine-containing compound of succinic acid derivative and a fluorine-containing compound of aliphatic ester shown below at the same mass amounts in a 1/2/7 mixed solvent of MEK/hexane/ethanol.

HOOCCH(C₁₄H₂₉)CH₂COOCH₂CH₂(CF₂)₇CF₃

CH₃(C₁₆H₃₂)COOCH₂CH₂(CF₂)₇CF₃ (lubricant)

### Example 2

Shown in FIG. 2, a magnetic tape sample was prepared in the same manner as in Example 1, except for additionally forming a lubricant layer (8) on the back coating layer (6). The lubricant layer (8) was formed in the same manner as in the case of lubricant layer (5).

### Example 3

A magnetic tape sample was prepared in the same manner as in Example 1, except for changing the thickness of the metal layer (7) to 30 nm.

### Example 4

A magnetic tape sample was prepared in the same manner as in Example 1, except for changing the thickness of the metal layer (7) to 40 nm.

### Example 5

A magnetic tape sample was prepared in the same manner as in Example 1, except for using Co as the material for the metal layer (7).

### Example 6

A magnetic tape sample was prepared in the same manner as in Example 1, except for changing the thickness of the back coating layer (6) to 100 nm.

### Comparative Example 1

A magnetic tape sample was prepared in the same manner as in Example 1, except for not forming the metal layer (7), but directly forming a back coating layer (6) (a thickness of 10 nm) on the surface of PEN film (2) opposite to the surface where the magnetic layer (3) is formed.

### Comparative Example 2

A magnetic tape sample was prepared in the same manner as in Example 1, except for not forming the back coating layer (6), but forming the metal layer (7).

### Comparative Example 3

A magnetic tape sample was prepared in the same manner as in Example 1, except for not forming the metal layer (7), but directly forming a back coating layer.(6) at a thickness of 100 nm on the surface of PEN film (2) opposite to the surface where the magnetic layer (3) is formed.

### Comparative Example 4

A magnetic tape sample was prepared in the same manner as in Example 1, except for changing the thickness of the metal layer (7) to 60 nm.

### Comparative Example 5

A magnetic tape sample was prepared in the same manner as in Example 1, except for changing the thickness of the metal layer (7) to 100 nm.

[Running Durability]

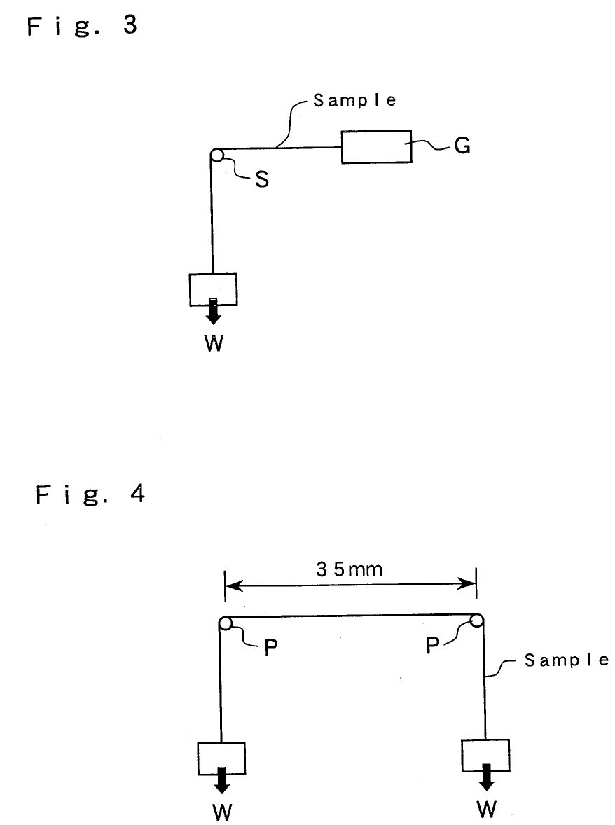

The coefficient of dynamic friction of the back coating layer surface side of the thus obtained magnetic tape samples was measured by using a sliding friction coefficient measuring apparatus as shown schematically in FIG. 3. Referring to FIG. 3, one end of the magnetic tape sample was attached to a strain gauge G, and load W was applied in such a manner that the sample may be brought into contact with the slide pin S. In order to evaluate the running durability of the magnetic tape, the magnetic tape sample was repeatedly slid against the slide pin S for 2,000 paths, and measurements were made on the initial coefficient of friction for the first path and the final coefficient of friction for the 2000th path. Further, as an indication of change in the coefficient of friction, the increase ratio of friction coefficient was calculated in accordance with equation 1. The generation of flaws on the sliding surface was observed after the measurement.

Increase ratio of friction coefficient (%)=[(final coefficient of friction−initial coefficient of friction)/initial coefficient of friction]×100 (Equation 1)

Material of slide pin: SUS303 φ2

Surface property of slide pin: 0.2 S

Winding angle: 90°

Sliding speed: 35 mm/s

Load: 20 gf

The evaluation of surface flaws was expressed based on the following standards.

◯: No flaws observed.

Δ: Few flaws are observed, but are of no practical problem.

×: Considerable amount of flaws are observed.

The same measurements as above were performed except for using above SUS303 φ2 pin as the slide pin S surface coated with DLC film.

(Electromagnetic Conversion Properties]

By using Mammoth-2 (manufactured by Exabyte Corporation) as the drive, the following measurements were performed under room temperature environment (at 20° C., 60%).

The drive above and the objective tape samples were each set in the above environment of measuring for 6 hours to be accustomed to the environment. While recording a sinusoidal wave at 2 T (21 MHz) in the drive by using Write head, reproduction was performed by using Read head. The reproduction output (RF) from the Read head was taken out from TP (test point) of the above drive, and the output for input frequency (21 MHz) was measured using a spectrum analyzer (Model 4395A manufactured by Agilent Technologies, Inc.). The measured value was displayed in relative values with respect to the measured value for the tape sample of Example 1 taken at 0 dB.

[Short Scale Durability]

By using Mammoth-2 (manufactured by Exabyte Corporation) as the drive and Vista (Visual SCSI Test Application) software provided by Exabyte Corporation, the following operation was conducted under room temperature environment (at 20° C., 60%).

The drive above and the objective tape samples were each set in the above environment of measuring for 6 hours to be accustomed to the environment. Random data of 288 Mbyte were undergone Write/Read process while the tape was run on the drive. The running pattern was set as such that the (Writing 288 Mbytes of data→Rewinding→Reading 288 Mbytes of data→Rewinding) sequence would be repeated. The runs were counted by incrementing the count per pattern above up to 1000 counts.

[Measurement of Cupping]

As shown in FIG. 4, 150 mm long magnetic tape sample was set with its magnetic layer side surface upward symmetrically on two supporting points (p) and (p) provided horizontally to right and left sides at a distance-of 35 mm from each center, and 0.3-g loads (w) and (w) were each set on the right and left ends of the tape. This thickness of deformation (mm) of the tape at the midpoint between the right and left ends was measured by measuring the shade width of a laser radiation. The thickness of deformation (mm) was employed as the observed value of cupping. In the case the observed value is positive, the tape is convex to the magnetic layer side; in the case the observed value is negative, the tape is convex to the back coating layer side.

TABLE 1
Test with metallic pin

| | | | | Flaws | | Electromagnetic | |
|---|---|---|---|---|---|---|---|
| | Friction coefficient | | | by sliding | | conversion | |
| | | | Increase ratio | After | Short scale | properties | Cupping |
| | 1 path | 2000 paths | (%) | 2000 paths | durability | (dB) | (mm) |
| Example 1 | 0.26 | 0.35 | 35 | ∘ | fine | 0 | 0.1 |
| Example 2 | 0.23 | 0.32 39 | ∘ | fine | 0 | 0.1 | |
| Example 3 | 0.23 | 0.33 | 43 | ∘ | fine | 0 | 0.1 |
| Example 4 | 0.24 | 0.35 | 46 | Δ | edge damage | −0.2 | 0.3 |
| Example 5 | 0.24 | 0.33 | 38 | Δ | edge damage | −0.3 | 0.2 |
| Example 6 | 0.24 | 0.32 | 33 | ∘ | fine | −0.5 | −0.3 |
| Comparative | 0.26 | 0.45 | 73 | x | running stop | 0 | 0 |
| Example 1 | | | | | | | |
| Comparative | 0.33 | 0.46 | 39 | x | running stop | −0.6 | 0.5 |
| Example 2 | | | | | | | |
| Comparative | 0.24 | 0.39 | 63 | x | running stop | 0 | −0.1 |
| Example 3 | | | | | | | |
| Comparative | 0.26 | 0.39 | 50 | Δ | running stop | −0.7 | 0.6 |
| Example 4 | | | | | | | |
| Comparative | 0.25 | 0.40 | 60 | Δ | running stop | −1 | 0.9 |
| Example 5 | | | | | | | |

TABLE 2
Test with DLC-treated metallic pin

| | | | | | | Electro- |
|---|---|---|---|---|---|---|
| | | | | Flaws | | magnetic |
| | Friction coefficient | | | by sliding | | conversion |
| | | | Increase ratio | After | Short scale | properties |
| | 1 path | 2000 paths | (%) | 2000 paths | durability | (dB) |
| Example 1 | 0.23 | 0.25 | 9 | ∘ | fine | 0 |
| Example 2 | 0.23 | 0.24 | 4 | ∘ | fine | 0 |
| Example 3 | 0.23 | 0.24 | 4 | ∘ | fine | 0 |
| Example 4 | 0.23 | 0.26 | 13 | ∘ | fine | −0.2 |
| Example 5 | 0.23 | 0.26 | 13 | ∘ | fine | −0.3 |
| Example 6 | 0.22 | 0.23 | 5 | ∘ | fine | −0.5 |
| Comparative | 0.23 | 0.30 | 30 | Δ | edge damage | 0 |
| Example 1 | | | | | | |
| Comparative | 0.26 | 0.32 | 23 | x | edge damage | −0.6 |
| Example 2 | | | | | | |
| Comparative | 0.22 | 0.36 | 64 | Δ | running stop | 0 |
| Example 3 | | | | | | |
| Comparative | 0.22 | 0.26 | 18 | ∘ | edge damage | −0.7 |
| Example 4 | | | | | | |
| Comparative | 0.24 | 0.28 | 17 | ∘ | edge damage | −1 |
| Example 5 | | | | | | |

The results thus obtained are summarized in Table 1 and Table 2. Table 1 shows the results concerning SUS303 φ2 pin. Table 1 reads that an increase in coefficient of sliding friction is suppressed for all the tape samples of Examples 1 to 6, and that no flaws generated on the sliding surface (Examples 1 to 3, and 6) or that the flaws generated only slightly in a practically negligible level (Examples 4 and 5). Further, the electromagnetic conversion properties as well as short scale durability of the samples were favorable as compared with those of the comparative examples.

In comparative examples 1 and 3 having no metal layers, on the contrary, considerable increase in coefficient of sliding friction and generation of many flaws on the sliding surface were observed, and causing running stops. In comparative example 2, in which back coating layer was missing, many flaws generated on the sliding surface, and large cupping occurred to cause running stops. In comparative examples 4 and 5, since the metal layer was too thick, large cupping occurred to cause running stops, further to deteriorate electromagnetic conversion properties.

Table 2 shows the results obtained for the case concerning DLC-coating treated SUS303 φ2 pin. Table 2reads that favorable results are obtained concerning slide flaws with the sliding pin DLC-coating treated, except for the sample of comparative example 2. However, by taking the increase ratio in friction coefficient into consideration, it was found that the samples of the examples yielded superior results as compared to those of comparative examples. In the case the slide pins are DLC-coating treated, considerable differences were also found to occur in the increase ratio of friction coefficient and running durability depending on whether metal layer is provided or not.

On measuring the refractive index of the film formed on an Si wafer under the same conditions for forming the back coating layer (DLC film) in each examples and comparative examples by using an ellipsometer (manufactured by Mizojiri Kogaku Kogyo K. K.),those values were found to be 2.1. Furthermore, the atomic ratio of hydrogen to carbon (H/C) measured by means of ERDA (Elastic Recoil Detection Analysis) was found to be 0.3. Further, it was found that the back coating layers of each examples and comparative examples have broad peaks at 1,560 cm⁻¹ and 1,330 cm⁻¹ in Raman spectroscopy.

What is claimed is:

1. A magnetic recording medium which comprises at least a magnetic layer and a protective layer comprising a hard film containing carbon as a principal component in this order on one surface of a non-magnetic support, and comprises a metal layer from 1 to 50 nm in thickness and a back coating layer comprising a hard film containing carbon as a principal component in this order on the other surface of said non-magnetic support.

2. The magnetic recording medium according to claim 1, wherein said magnetic layer is a metal thin film type magnetic layer.

3. The magnetic recording medium according to claim 1, wherein said back coating layer comprising said hard film containing carbon as a principal component is formed by a vacuum film forming method.

4. The magnetic recording medium according to claim 1, wherein said back coating layer has a thickness of from 3 to 300 nm.

5. The magnetic recording medium according to claim 1, wherein said metal layer is formed by employing, as a raw material, at least one selected from the group consisting of Al, Ag, Cr, Cu, Mn, Ti, Co, Ni, Zn, and alloys of said metals.

6. The magnetic recording medium according to claim 1, wherein the electric resistivity of said metal layer is in the range of from 10⁻² to 10¹⁰ Ω·cm.

7. The magnetic recording medium according to claim 1, which further comprises a lubricant layer on said protective layer.

8. The magnetic recording medium according to claim 1, which further comprises a lubricant layer on said back coating layer.

9. A magnetic recording/reproducing system, for recording and reproducing a tape-like magnetic recording medium according to claim 1, by using a magnetic recording/reproducing device having a member on which the hard film containing carbon as a principal component is formed at parts in contact with a surface of said back coating layer.
